(19) United States
(12) Patent Application Publication
(10) Pub. No.: US 2011/0303569 A1
(43) Pub. Date: Dec. 15, 2011

(54) CASE FOR BATTERY POWERED TOOTHBRUSH SYSTEM

(76) Inventor: Michael L. Johnson, Chicago, IL (US)

(21) Appl. No.: 13/092,432

(22) Filed: Apr. 22, 2011

Related U.S. Application Data
(60) Provisional application No. 61/355,061, filed on Jun. 15, 2010.

(51) Int. Cl. A47K 1/09; A61C 17/00

(52) U.S. Cl. 206/361; 433/216

(57) ABSTRACT

A toothbrush holding device for battery-powered toothbrush(es) comprises a top piece; a bottom piece; at least one sturdy hinge; and an interlocking clasp fastener. The top piece of the toothbrush holding device for battery-powered toothbrush(es) is hingably-coupleable to the bottom piece via the hinge to temporarily sanitarily store the (fully) assembled battery-powered toothbrush during a non-use period. The toothbrush holding device is rectangular in shape, manufactured from plastic material, and is form-fitting to the battery-powered toothbrush such that the battery-powered toothbrush is prevented from moving within the toothbrush holding device. Further, the toothbrush holding device comprises soft, rounded edges. The toothbrush holding device is about 9¼-inches in length, about 1½-inch in width when in a closed position, and about 1⅛ inch in depth thereby permitting the battery-powered toothbrush to be in an assembled state when stored in the toothbrush holding device.

### CROSS-REFERENCE TO RELATED APPLICATION

The present application is related to and claims priority from prior provisional application Ser. No. 61/355,061, filed Jun. 15, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of cases and more specifically relates to cases for use with battery powered toothbrushes.

2. Description of the Related Art

Brushing one's teeth is one of the most important parts of healthy hygiene. In addition to freshening the breath and strengthening the teeth, proper brushing also kills the germs and bacteria that can grow inside the mouth. Recently, the Office of the Surgeon General released its first ever report on the oral health of America and the results were surprising. According to the report, the most common chronic childhood disease by far in this country is tooth decay. In fact, American children lose a staggering 512 million school hours a year due to dental related illness. Adults also suffer from various forms of dental disease and these complications can lead to painful oral surgeries and costly trips to the dentist.

A booming industry, the national health expenditures for dental services exceeded sixty billion dollars in the year 2007. While the Office of the Surgeon General reports that there have been vast improvements in the past fifty years regarding oral health issues, much can still be done in this area. Health professionals maintain that through education and a concerted effort, the number of adults and children suffering from dental disease can be significantly reduced.

Toothbrushes are typically a manual or electric instrument consisting of a small brush on a handle used to clean teeth through tooth brushing. Toothpaste, often containing fluoride, is commonly added to a toothbrush to clean the teeth of the brusher-user. Toothbrushes are offered with varying textures of bristles, and may come in many different sizes and forms.

An electric toothbrush is a toothbrush that uses electric power to move the brush head, normally in an oscillating or rotary pattern. Modem electric toothbrushes run on low voltage, typically 12v or less. A few units still use a step-down transformer to power the hand piece, but most use power from a rechargeable battery in the hand piece. The electronic compartments in most of the electric toothbrushes are completely sealed to prevent water damage. Often these electric toothbrushes may come into contact with unsanitary surfaces when stored potentially compromising the health of it brusher-user.

Typically, electric toothbrushes are powered by replaceable or rechargeable batteries housed in the base of the handle of the brush, thus adding bulk to the handle. In this manner, an electric toothbrush is simply too large to fit in a conventional toothbrush case and thus users have no choice but to leave these brushes out in the open when stored. Although many people utilize free standing or wall mounted toothbrush holders to store their electric toothbrushes, these storage units are typically constructed with an open design, thus leaving the brush head and bristles of the toothbrush exposed to a plethora of harmful agents found in the bathroom. As unpleasant as it may seem, germs and bacteria thrive in the bathroom and the simple act of flushing the toilet can render an exposed toothbrush contaminated. In addition to germs and bacteria, other unpleasant elements such as hair, microscopic skin cells, hairspray and perfumes can settle on the exposed bristles of a toothbrush and are deposited directly into the mouth every time one brushes their teeth.

Various attempts have been made to solve problems found in tooth brush case art. Among these are found in: U.S. Pat. No. 5,052,556 to Wilkinson; U.S. Pat. No. 5,095,924 to Stanfield; and U.S. Pat. No. 5,505,301 to Foley. This prior art is representative of tooth brush cases.

Ideally, a case for battery powered toothbrush should be user-friendly and yet, would operate reliably and be manufactured at a modest expense. Thus, a need exists for a reliable a case for battery powered toothbrush system to protect a battery powered toothbrush when not in use while providing sanitary storage means and to avoid the above-mentioned problems.

### BRIEF SUMMARY OF THE INVENTION

In view of the foregoing disadvantages inherent in the known toothbrush case art, the present invention provides a novel case for battery powered toothbrush system. The general purpose of the present invention, which will be described subsequently in greater detail is to provide sanitary storage means for battery-powered toothbrush(es) when not in use.

The present toothbrush holding device for battery-powered toothbrush(es) as disclosed herein comprises: a top piece; a bottom piece; at least one sturdy hinge; and an interlocking clasp fastener. The top piece of the toothbrush holding device for battery-powered toothbrush(es) is hingably-coupleable to the bottom piece via the hinge to temporarily sanitarily store the battery-powered toothbrush during a non-use period. The toothbrush holding device for battery-powered toothbrush(es) may be manufactured from plastic material.

The toothbrush holding device is preferably rectangular in shape and is form-fitting to the battery-powered toothbrush such that the battery-powered toothbrush is prevented from moving within the toothbrush holding device. Further, the toothbrush holding device comprises soft, rounded edges. The toothbrush holding device is about 9¼-inches in length, about 1½-inch in width when in a closed position, and about 1⅛ inch in depth thereby permitting the battery-powered toothbrush to be in an assembled state when stored in the toothbrush holding device.

The sturdy hinge fastener may be located about two-inches from a top end of the toothbrush holding device and about two-inches from a bottom end of the toothbrush holding device.

The interlocking clasp fastener is preferably centrally-located between the top end and the bottom end on the top piece. Further, the clasp fastener permits a user to temporarily secure the toothbrush holding device in closed position thereby preventing germs from contacting a surface of the battery-powered toothbrush.

A kit is embodied herein for the case for the battery powered toothbrush system comprising: a toothbrush holding device for battery-powered toothbrush(es); a battery-powered toothbrush; and a set of user instructions.

In accordance with the embodiments of the present invention a preferred method of use is disclosed herein comprising: opening a case of the battery-powered toothbrush system; removing a battery-powered toothbrush from the case of battery-powered toothbrush system; a user grasping a handle of the battery-powered toothbrush and dispensing toothpaste onto bristles of the battery-powered toothbrush; initiating the brushing of teeth of the user; and inserting the battery-powered toothbrush back into the case for battery powered toothbrush system once the user is finished brushing his/her teeth.

The present invention holds significant improvements and serves as a case of the battery-powered toothbrush system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, case for battery powered toothbrush(es) system, constructed and operative according to the teachings of the present invention.

FIG. 1 shows a perspective view illustrating a case for a battery powered toothbrush(es) system in an ‘in-use’ position according to an embodiment of the present invention

FIG. 2 is a perspective view illustrating a toothbrush holding device for battery-powered toothbrush(es) of the case for a battery powered toothbrush(es) system in an open position according to an embodiment of the present invention.

FIG. 3 is a perspective view illustrating the toothbrush holding device for battery-powered toothbrush(es) of the case for a battery powered toothbrush(es) system in a closed position according to an embodiment of the present invention.

FIG. 4 is a flowchart illustrating a method of use according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a case device and more particularly to case for use with an electric toothbrush(es) system 100 as used to improve the sanity storage and transport of electric toothbrushes.

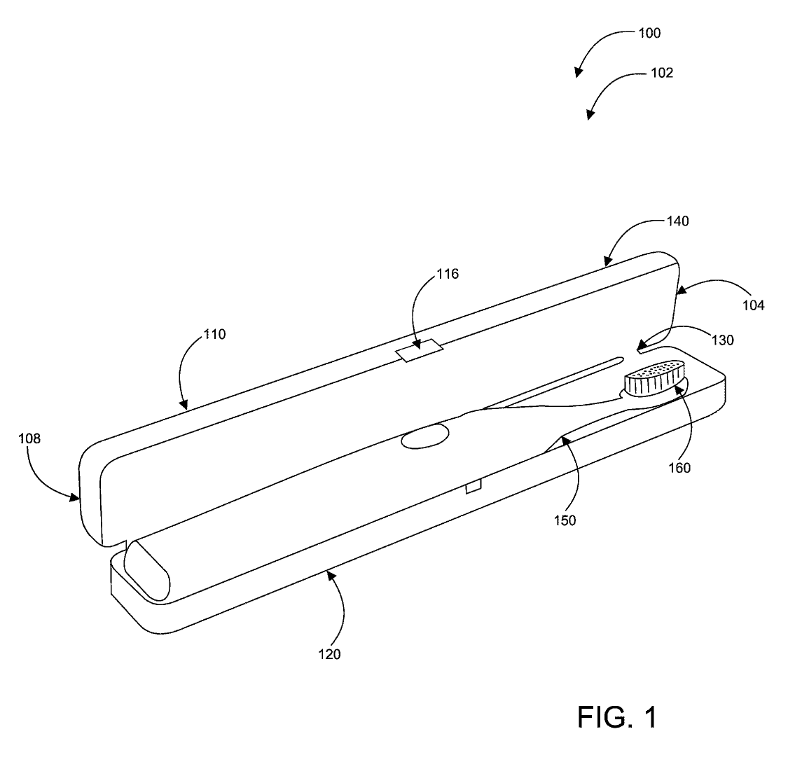

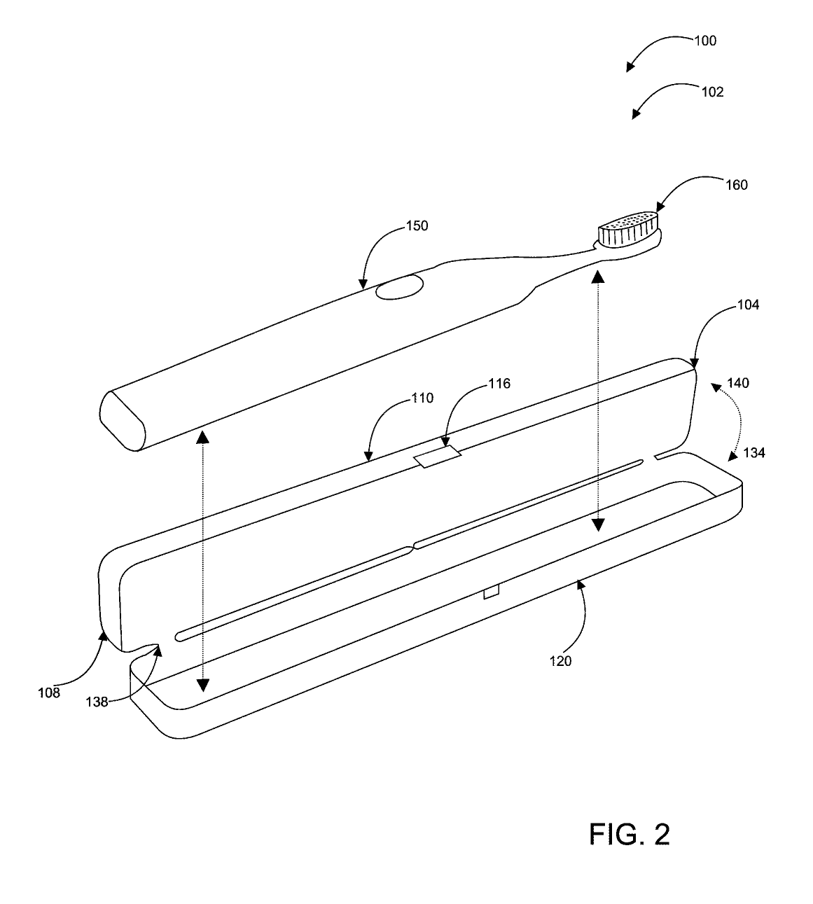

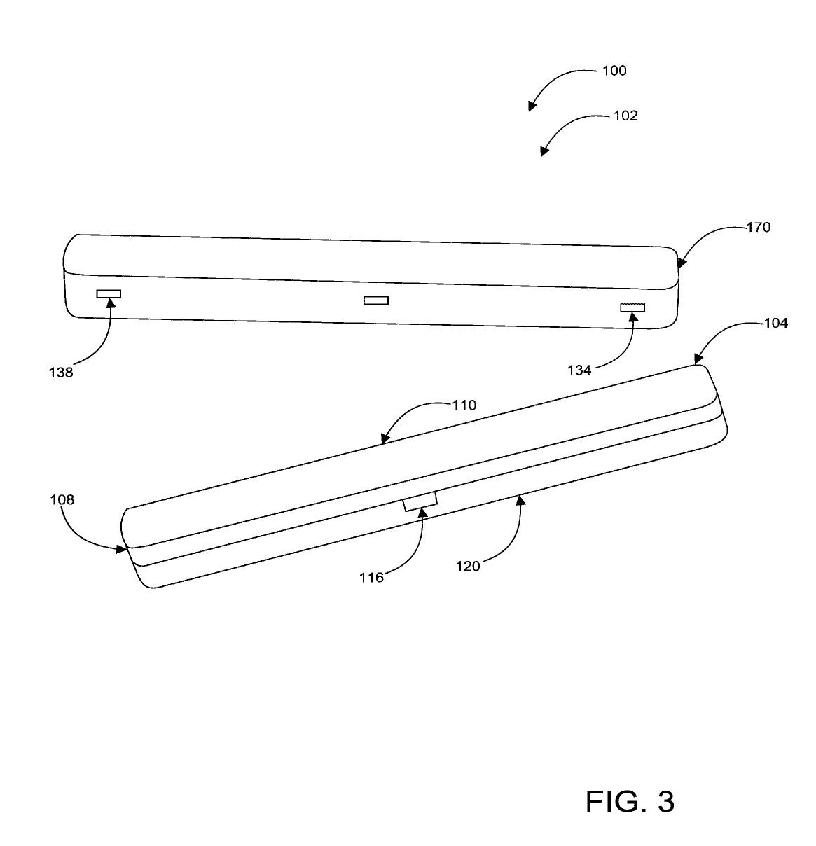

Referring now to the drawings FIGS. 1-3, showing perspective views of case for use with an electric toothbrush(es) system 100 according to embodiments of the present invention. Case for use with an electric toothbrush(es) system 100 comprises toothbrush holding device for battery-powered toothbrush(es) 102. Toothbrush holding device for battery-powered toothbrush(es) 102 preferably includes a specially designed storage unit configured specifically for use in storing battery-powered (electric) toothbrush(es) 150. Toothbrush holding device for battery-powered toothbrush(es) 102 preferably comprises top piece 110; bottom piece 120; and at least one hinge 130 (suitable hinging means.) Top piece 110 is preferably is hingably-coupleable to bottom piece 120 via hinge 130 to temporarily sanitarily store battery-powered toothbrush(es) 150 during a non-use period as shown best in FIG. 1. FIGS. 1 and 3 show case for use with an electric toothbrush(es) system 100 effectively stored and available for transport. FIGS. 1 and 2 illustrate case for use with an electric toothbrush(es) system 100 in open position 140 made possible by hinge 130.

Toothbrush holding device for battery-powered toothbrush(es) 102 preferably comprises sturdy, yet lightweight material. Lightweight material is preferably plastic, however other lightweight materials such as rubber may be used rendering the device light for ease of carrying during travel periods. Toothbrush holding device for battery-powered toothbrush(es) 102 is preferably rectangular in shape and is form-fitting to battery-powered toothbrush(es) 150 such that battery-powered toothbrush is effectively prevented from moving within case for use with an electric toothbrush(es) system 100. Form-fitting means may comprise rubber grips to prevent the displacement of battery-powered toothbrush(es) 150 during non-use periods, thus serving to prevent impact and vibration damage to battery-powered toothbrush(es) 150. Further, toothbrush holding device for battery-powered toothbrush(es) 102 preferably comprises soft, rounded edges to substantially prevent a user from injuring themselves on a sharp corner. Further, the soft, rounded edges may contour to a hand of the user while grasping toothbrush holding device for battery-powered toothbrush(es) 102.

Toothbrush holding device for battery-powered toothbrush(es) 102 is preferably is about 9¼-inches in length thereby permitting battery-powered toothbrush(es) 150 to be in a fully assembled state when stored in toothbrush holding device for battery-powered toothbrush(es) 102. In this way the present invention allows for convenience of it brusher-user, whereby battery-powered toothbrush 150 does not require assembly, but rather is ready for immediate use. Additionally, toothbrush holding device for battery-powered toothbrush(es) 102 is about 1½-inch in width when in closed position 170, and about 1⅛ inch in depth thereby accommodating a wide range of manufacturers and types (styles) of battery-powered toothbrush(es) 150. It should be appreciated that other sizes and shapes may be made to fit battery-powered toothbrush(es) 150.

As mentioned above, toothbrush holding device for battery-powered toothbrush(es) 102 is preferably a hinged unit (hinge 130), further comprising two sturdy (durable through repeated actions) hinge fasteners, 134, and 138 respectfully. First sturdy hinge fastener 134 is preferably located about two-inches from top end 104 of toothbrush holding device for battery-powered toothbrush(es) 102 while second sturdy hinge fastener 138 is preferably located about two-inches from bottom end 108 of toothbrush holding device for battery-powered toothbrush(es) 102.

Interlocking clasp fastener 116 may also be included and centrally-located between top end 104 and bottom end 108 on top piece 110 of case for use with an electric toothbrush(es) system 100. Interlocking clasp fastener 116 preferably permits the user to temporarily secure case for use with toothbrush holding device for battery-powered toothbrush(es) 102 in a closed position 170 thereby preventing germs from contacting surface 160 of battery-powered toothbrush(es) 150. Further, interlocking clasp fastener 116 effectively prevents toothbrush holding device for battery-powered toothbrush(es) 102 from opening during transport, and/or shipping. Surface 160 preferably comprises a bristle-head of battery-powered toothbrush(es) 150.

Toothbrush holding device for battery-powered toothbrush(es) 102 may be produced in a myriad of vibrant colors and printed designs, as well as in a host of neutral hues, especially beneficial for children and young adults. In this way toothbrush holding device for battery-powered toothbrush(es) 102 provides efficient, sanitary storage for battery-powered toothbrush(es) 150 thereby preferably promoting health in its brusher-users and enticing children to use the present invention and to brush their teeth.

Case for battery powered toothbrush system 100 may be sold as kit 340 comprising toothbrush holding device for battery-powered toothbrush(es) 102; battery-powered toothbrush(es) 150; and a set of user instructions. Other dental devices may be included within kit 340. Case for battery powered toothbrush system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

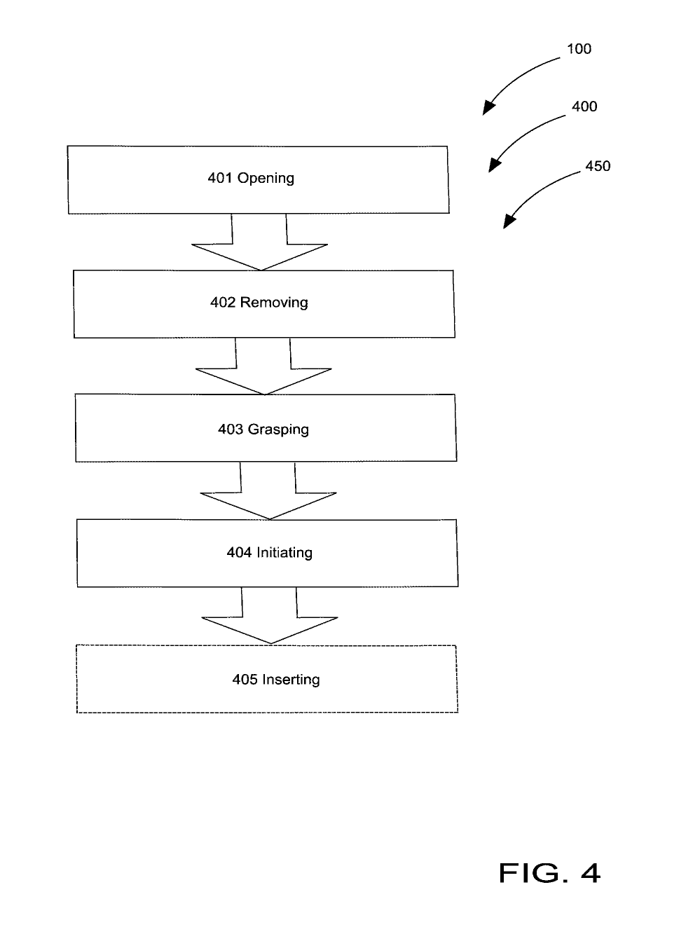

FIG. 4. shows a flowchart 450 illustrating a method of use 400 according to an embodiment of the present invention of FIGS. 1-3. Referring now to FIG. 4. showing a method (at least herein embodying method of use 400) of using toothbrush holding device for battery-powered toothbrush(es) 102 preferably comprises the steps of: step one 401 opening case for use with an electric toothbrush(es) system 100; step two 402 removing battery-powered toothbrush 150 from case of battery-powered toothbrush system 100; step three 403 a user grasping a handle of battery-powered toothbrush(es) 150 and dispensing toothpaste onto bristles of battery-powered toothbrush 150; step four 404 initiating the brushing of teeth of the user; and step five 405 inserting battery-powered toothbrush 150 back into case for use with an electric toothbrush(es) system 100 once the user is finished brushing their teeth.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A toothbrush holding device for battery-powered toothbrush(es) comprising:
a top piece;
a bottom piece; and
at least one hinge;
wherein said top piece is hingably-coupleable to said bottom piece via said hinge to temporarily sanitarily store assembled said battery-powered toothbrush during a non-use period.

2. The toothbrush holding device for battery-powered toothbrush(es) of claim 1 wherein said toothbrush holding device comprises lightweight material.

3. The toothbrush holding device for battery-powered toothbrush(es) of claim 2 wherein said lightweight material is plastic.

4. The toothbrush holding device for battery-powered toothbrush(es) of claim 1 wherein said toothbrush holding device is rectangular in shape and is form-fitting to assembled said battery-powered toothbrush such that assembled said battery-powered toothbrush is prevented from moving within said toothbrush holding device.

5. The toothbrush holding device for battery-powered toothbrush(es) of claim 4 wherein said toothbrush holding device comprises soft, rounded edges.

6. The toothbrush holding device for battery-powered toothbrush(es) of claim 1 wherein said toothbrush holding device is about 9¼-inches in length thereby permitting said battery-powered toothbrush to be in an assembled state when stored in said toothbrush holding device.

7. The toothbrush holding device for battery-powered toothbrush(es) of claim 1 wherein said toothbrush holding device is about 1½-inch in width when in a closed position.

8. The toothbrush holding device for battery-powered toothbrush(es) of claim 1 wherein said toothbrush holding device is about 1⅛ inch in depth.

9. The toothbrush holding device for battery-powered toothbrush(es) of claim 1 wherein said at least one hinge comprises a sturdy hinge fastener.

10. The toothbrush holding device for battery-powered toothbrush(es) of claim 9 wherein said sturdy hinge fastener is located about two-inches from a top end of said toothbrush holding device.

11. The toothbrush holding device for battery-powered toothbrush(es) of claim 9 wherein said sturdy hinge fastener is located about two-inches from a bottom end of said toothbrush holding device.

12. The toothbrush holding device for battery-powered toothbrush(es) of claim 1 further comprises an interlocking clasp fastener.

13. The toothbrush holding device for battery-powered toothbrush(es) of claim 12 wherein said interlocking clasp fastener is centrally-located between said top end and said bottom end on said top piece.

14. The toothbrush holding device for battery-powered toothbrush(es) of claim 13 wherein said interlocking clasp fastener permits a user to temporarily secure said toothbrush holding device in a closed condition thereby preventing germs from contacting a surface of said battery-powered toothbrush.

15. A plastic toothbrush holding device for battery-powered toothbrush(es) comprising:
a top piece;
a bottom piece;
at least one sturdy hinge fastener located about two-inches from a top end and about two-inches from a bottom end of said toothbrush holding device; and
an interlocking clasp fastener centrally-located between said top end and said bottom end on said top piece;
wherein said top piece is hingably-coupleable to said bottom piece via said hinge to temporarily sanitarily store said battery-powered toothbrush during a non-use period;
wherein said toothbrush holding device is rectangular in shape and is form-fitting to said battery-powered toothbrush such that assembled said battery-powered toothbrush is prevented from moving within said toothbrush holding device;
wherein said toothbrush holding device comprises soft, rounded edges;
wherein said toothbrush holding device is about 9¼-inches in length thereby permitting said battery-powered toothbrush to be in an assembled state when stored in said toothbrush holding device;
wherein said toothbrush holding device is about 1½-inch in width when in a closed position;
wherein said toothbrush holding device is about 1⅛ inch in depth; and
wherein said interlocking clasp fastener permits a user to temporarily secure said toothbrush holding device in a closed condition thereby preventing germs from contacting a surface of said battery-powered toothbrush.

16. The toothbrush holding device for battery-powered toothbrush(es) of claim 15 further comprising a kit including: said toothbrush holding device for battery-powered toothbrush(es); a battery-powered toothbrush; and a set of user instructions.

17. A method of using a case for battery powered toothbrush system comprising the steps of:
opening a case of said battery-powered toothbrush system;
removing a battery-powered toothbrush from said case of battery-powered toothbrush system;
a user grasping a handle of said battery-powered toothbrush and dispensing toothpaste onto bristles of said battery-powered toothbrush;
initiating brushing of teeth of said user; and
inserting said battery-powered toothbrush back into said case for battery powered toothbrush system once said user is finished brushing said teeth.
